(19) United States
(12) Patent Application Publication
(10) Pub. No.: US 2017/0249580 A1
(43) Pub. Date: Aug. 31, 2017

(54) AUTOMATING TASK PROCESSING

(71) Applicant: Microsoft Technology Licesning, LLC, Redmond, WA (US)

(72) Inventors: Todd D. Newman, Mercer Island, WA (US); Emad M. Elwany, Kirkland, WA (US); Andres Monroy-Hernandez, Seattle, WA (US); Justin Brooks Cranshaw, Seattle, WA (US)

(21) Appl. No.: 15/493,749

(22) Filed: Apr. 21, 2017

Related U.S. Application Data
(63) Continuation-in-part of application No. 15/055,522, filed on Feb. 26, 2016.

(51) Int. Cl. G06Q 10/06; G06N 7/00; G06Q 10/10

(52) U.S. Cl. CPC G06Q 10/063116; G06Q 10/0633; G06Q 10/1095; G06N 7/005

(57) ABSTRACT

Aspects extend to methods, systems, and computer program products for automating task processing. Assisted microtasking is used to facilitate an incremental introduction of automation to handle more and more of scheduling related work over time as the automation become more effective. Incremental introduction of automation permits delivery of higher quality results (via human worker verification) prior to acquiring sufficient training data for fully automated solutions. Assisted microtasking can be used to increase human worker efficiency by using automation to do much of the work. The human worker's involvement can be essentially reduced to one of (e.g., YES/NO) verification. Aspects of the invention can be used to bootstrap data collection, for example, in “small data” scenarios. Proposition providers can be deployed before they are fully robust and can learn incrementally as data is gathered from human workers

### CROSS-REFERENCE TO RELATED APPLICATIONS

This application is a continuation-in-part of and claims the benefit of and priority to U.S. patent application Ser. No. 15/055,522, entitled “Automated Task Processing With Escalation”, filed Feb. 26, 2016 by Justin Brooks Cranshaw et. al., the entire contents of which are expressly incorporated by reference.

### BACKGROUND

### 1. Background and Relevant Art

Computer systems and related technology affect many aspects of society. Indeed, the computer system's ability to process information has transformed the way we live and work. More recently, computer systems have been coupled to one another and to other electronic devices to form both wired and wireless computer networks over which the computer systems and other electronic devices can transfer electronic data. Accordingly, the performance of many computing tasks is distributed across a number of different computer systems and/or a number of different computing environments. For example, distributed applications can have components at a number of different computer systems.

One task people often perform with the assistance of a computer is scheduling meetings. A person can use a computer to schedule their own meetings or can delegate the scheduling of meetings to an assistant. Scheduling meetings is a relatively complex task, because it includes bringing multiple people to consensus. Often such discussions take place over email and require many iterations before an acceptable time is found. Further, even after agreement has been reached, one of the parties may have to reschedule or cancel the meeting.

Scheduling and rescheduling meetings are problems typically solved by human assistants. However, hiring a full-time human assistant can be relatively expensive, especially for smaller businesses. As such, some mechanisms for using digital assistants to handle scheduling and rescheduling of meetings have been developed.

One mechanism primarily uses machine learning to schedule and reschedule meetings. However, if scheduling cannot be automated, the meeting creator is required to intervene and take over manually. Another mechanism uses shifts of workers to schedule and reschedule meetings for a group of other users. Thus, this other mechanism still relies primarily on humans and can be also be subject to delays due to workers going off shift.

A further mechanism uses a shared page on which meeting request recipients see a list of times that potentially work for a meeting creator. Recipients interact directly with the shared page on which they see the options and select times that work for them. A computer determines when all invitees have responded and reports either success or failure to reach closure. While having some advantages, this further mechanism still places a significant burden on a meeting initiator. This further mechanism also fails to allow direct negotiations between recipients or multiple iterations of scheduling.

### BRIEF SUMMARY

Examples extend to methods, systems, and computer program products for automating task processing. A request is received to perform a task (e.g., a scheduling task). A workflow for the task is accessed from system memory. The workflow defines a plurality of sub-tasks to be completed to perform the scheduling task.

For each sub-task, the sub-task is sent to one or more automated task processing providers. Each of the one or more automated task processing providers automatically provides a proposed solution for the sub-task. For each sub-task, one or more proposed solutions for performing the sub-task are received from the one or more automated task processing providers.

For each sub-task, the one or more proposed solutions are forwarded to a (e.g., human) worker for verification. For each sub-task, a response from the worker is received. The response indicates at least one appropriate solution for the sub-task. The sub-task is executed using a solution from among the at least one appropriate solutions. For each sub-task, the response can be used as feedback for training the one or more automated task processing providers to propose more effective sub-task solutions.

This summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages will be set forth in the description which follows, and in part will be obvious from the description, or may be learned by practice. The features and advantages may be realized and obtained by means of the instruments and combinations particularly pointed out in the appended claims. These and other features and advantages will become more fully apparent from the following description and appended claims, or may be learned by practice as set forth hereinafter.

### BRIEF DESCRIPTION OF THE DRAWINGS

In order to describe the manner in which the above-recited and other advantages and features can be obtained, a more particular description will be rendered by reference to specific implementations thereof which are illustrated in the appended drawings. Understanding that these drawings depict only some implementations and are not therefore to be considered to be limiting of its scope, implementations will be described and explained with additional specificity and detail through the use of the accompanying drawings in which:

FIG. 1 illustrates an example computer architecture that facilitates automating task processing.

FIG. 2 illustrates a flow chart of an example method for automating task processing.

FIG. 3 illustrates an example architecture that facilitates automated task processing with escalation.

FIG. 4 illustrates a flow chart of an example method for automated task processing with escalation.

### DETAILED DESCRIPTION

Examples extend to methods, systems, and computer program products for automating task processing. A request is received to perform a task (e.g., a scheduling task). A workflow for the task is accessed from system memory. The workflow defines a plurality of sub-tasks to be completed to perform the scheduling task.

For each sub-task, the sub-task is sent to one or more automated task processing providers. Each of the one or more automated task processing providers automatically provides a proposed solution for the sub-task. For each sub-task, one or more proposed solutions for performing the sub-task are received from the one or more automated task processing providers.

For each sub-task, the one or more proposed solutions are forwarded to a (e.g., human) worker for verification. For each sub-task, a response from the worker is received. The response indicates at least one appropriate solution for the sub-task. The sub-task is executed using a solution from among the at least one appropriate solutions. For each sub-task, the response can be used as feedback for training the one or more automated task processing providers to propose more effective sub-task solutions.

Implementations may comprise or utilize a special purpose or general-purpose computer including computer hardware, such as, for example, one or more computer and/or hardware processors (including Central Processing Units (CPUs) and/or Graphical Processing Units (GPUs)) and system memory, as discussed in greater detail below. Implementations also include physical and other computer-readable media for carrying or storing computer-executable instructions and/or data structures. Such computer-readable media can be any available media that can be accessed by a general purpose or special purpose computer system. Computer-readable media that store computer-executable instructions are computer storage media (devices).

Computer-readable media that carry computer-executable instructions are transmission media. Thus, by way of example, and not limitation, implementations can comprise at least two distinctly different kinds of computer-readable media: computer storage media (devices) and transmission media.

Computer storage media (devices) includes RAM, ROM, EEPROM, CD-ROM, Solid State Drives (“SSDs”) (e.g., RAM-based or Flash-based), Shingled Magnetic Recording (“SMR”) devices, Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

In one aspect, one or more processors are configured to execute instructions (e.g., computer-readable instructions, computer-executable instructions, etc.) to perform any of a plurality of described operations. The one or more processors can access information from system memory and/or store information in system memory. The one or more processors can (e.g., automatically) transform information between different formats, such as, for example, between any of: sub-tasks, proposed sub-task solutions, predicted sub-task solutions, schedule tasks, calendar updates, asynchronous communication, worker responses, solution results, feedback, failures, escalated sub-tasks, escalated tasks, workflows, automated tasks, microtasks, macrotasks, etc.

System memory can be coupled to the one or more processors and can store instructions (e.g., computer-readable instructions, computer-executable instructions, etc.) executed by the one or more processors. The system memory can also be configured to store any of a plurality of other types of data generated and/or transformed by the described components, such as, for example, sub-tasks, proposed sub-task solutions, predicted sub-task solutions, schedule tasks, calendar updates, asynchronous communication, worker responses, solution results, feedback, failures, escalated sub-tasks, escalated tasks, workflows, automated tasks, microtasks, macrotasks, etc.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to computer storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. Thus, it should be understood that computer storage media (devices) can be included in computer system components that also (or even primarily) utilize transmission media.

Computer-executable instructions comprise, for example, instructions and data which, in response to execution at a processor, cause a general purpose computer, special purpose computer, or special purpose processing device to perform a certain function or group of functions. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the described aspects may be practiced in network computing environments with many types of computer system configurations, including, personal computers, desktop computers, laptop computers, message processors, hand-held devices, wearable devices, multicore processor systems, multi-processor systems, microprocessor-based or programmable consumer electronics, network PCs, minicomputers, mainframe computers, mobile telephones, PDAs, tablets, routers, switches, and the like. The described aspects may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Further, where appropriate, functions described herein can be performed in one or more of: hardware, software, firmware, digital components, or analog components. For example, one or more application specific integrated circuits (ASICs) can be programmed to carry out one or more of the systems and procedures described herein. In another example, computer code is configured for execution in one or more processors, and may include hardware logic/electrical circuitry controlled by the computer code. These example devices are provided herein purposes of illustration, and are not intended to be limiting. Embodiments of the present disclosure may be implemented in further types of devices.

The described aspects can also be implemented in cloud computing environments. In this description and the following claims, “cloud computing” is defined as a model for enabling on-demand network access to a shared pool of configurable computing resources. For example, cloud computing can be employed in the marketplace to offer ubiquitous and convenient on-demand access to the shared pool of configurable computing resources (e.g., compute resources, networking resources, and storage resources). The shared pool of configurable computing resources can be provisioned via virtualization and released with low effort or service provider interaction, and then scaled accordingly.

A cloud computing model can be composed of various characteristics such as, for example, on-demand self-service, broad network access, resource pooling, rapid elasticity, measured service, and so forth. A cloud computing model can also expose various service models, such as, for example, Software as a Service (“SaaS”), Platform as a Service (“PaaS”), and Infrastructure as a Service (“IaaS”). A cloud computing model can also be deployed using different deployment models such as private cloud, community cloud, public cloud, hybrid cloud, and so forth. In this description and in the following claims, a “cloud computing environment” is an environment in which cloud computing is employed.

Assisted Microtasks

Task processing can take advantage of machine learning and microtasks to appropriately handle scheduling problems. A larger (or overall) task to be achieved (e.g., scheduling a meeting between multiple participants) can be broken down into a grouping of (e.g., loosely-coupled) asynchronous sub-tasks (e.g., microtasks). Completing the grouping of sub-tasks completes the larger (or overall) task. A larger (or overall) task can be a task that is delegated to a virtual assistant for completion (e.g., “schedule a meeting next week” or “book my travel plans”).

A microtask is an atomic sub-component of a task having a fixed input and output. If a task is “book my travel plans”, a microtask might be “what is the destination city?” A microtask can be executed by an automated (e.g., artificially intelligent) component and/or by a human worker (e.g., through a crowd-work platform).

Execution of tasks can be handled by a workflow engine. The workflow engine can process sub-tasks serially and/or in parallel based on inputs to and results from other sub-tasks. A microtask workflow is a (e.g., logical) procedure that connects a plurality of microtasks together to perform a larger task.

Aspects of the invention include assisted processing of microtasks (hereinafter referred to as “assisted microtasking”). Assisted microtasking combines human and machine intelligence in a single atomic unit of work to execute a larger (or overall) task. Assisted microtasking facilitates an incremental introduction of automation, that handle more and more of scheduling related work over time, as it becomes more effective. Incremental introduction of automation permits delivery of higher quality results (via human worker verification) prior to acquiring sufficient training data for fully automated solutions.

Assisted microtasking can be used to increase human worker efficiency by using automation to do much of the work. The human worker's involvement can be essentially reduced to one of (e.g., YES/NO) verification.

Microtasking can utilize an ensemble of (e.g., one or more) automated proposition providers. In one aspect, each microtask is sent to the ensemble of automated proposition providers. Each automated proposition provider in the ensemble automatically determines and provides one or more proposed solutions (or predictions) for the microtask. In one aspect, an automated proposition provider provides a confidence score with each proposed solution. The confidence score indicates how confident the proposition provider is that a proposed solution is an appropriate solution for a sub-task.

An automated proposition provider can be a machine learning classifier, trained using techniques, such as, decision trees, support vector machines, generative modelling, logistic regressions, or any number of common underlying technologies. Automated proposition providers can also utilize techniques in natural language processing, such as, entity detection, and may rely on parsing, conditional random fields, neural networks, information extraction, or any number of other techniques that extract entities from text.

The proposed solutions are combined into an ensemble of propositions. From the ensemble of propositions, a human worker can judge which solutions (or predictions), if any, are appropriate (e.g., correct) solutions (or predictions) for the microtask. Data gathered from human workers can be provided as feedback for training proposition providers.

Overtime, an ensemble learner can also gather data from human workers who complete assisted microtasks. Given a corpus of selection data made by human workers, the ensemble learner makes a prediction about which propositions to choose. In making a prediction, the ensemble learner may use features derived from the microtask input and proposition provider outputs, including a confidence score assessment and derived historical performance of each proposition provider. The ensemble learner can be implemented as a boosting algorithm, such as Adaptive Boosting, or other techniques. Other techniques can include: stacking, bagging, and Bayesian model combination.

Aspects of the invention can be used to bootstrap data collection, for example, in “small data” scenarios. Proposition providers can be deployed before they are fully robust and can learn incrementally as data is gathered from human workers.

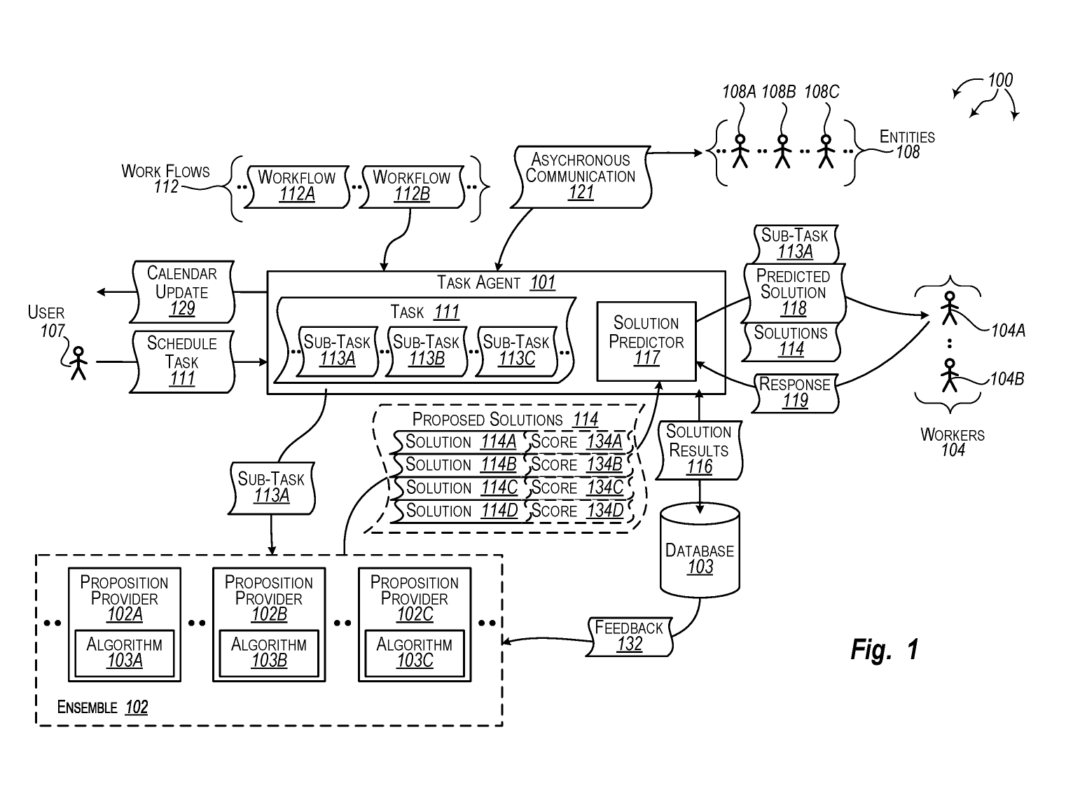

FIG. 1 illustrates an example computer architecture 100 that facilitates automating task processing. Referring to FIG. 1, computer architecture 100 includes task agent 101, ensemble (of proposition providers) 102, database 103, workers 104, entities 108, and workflows 112. Task agent 101, ensemble 102, database 103, workers 104 (e.g., through connected computer systems), entities 108, and workflows 112 can be connected to (or be part of) a network, such as, for example, a system bus, a Local Area Network (“LAN”), a Wide Area Network (“WAN”), and even the Internet. Accordingly, task agent 101, ensemble 102, database 103, workers 104, entities 108, and workflows 112 as well as any other connected computer systems and their components can create and exchange message related data (e.g., Internet Protocol (“IP”) datagrams and other higher layer protocols that utilize IP datagrams, such as, Transmission Control Protocol (“TCP”), Hypertext Transfer Protocol (“HTTP”), Simple Mail Transfer Protocol (“SMTP”), Simple Object Access Protocol (SOAP), etc. or using other non-datagram protocols) over the network.

Workflows 112 include workflows 112A, 112B, etc. Each of workflows 112 defines a plurality of sub-tasks to be completed to perform a task. That is, a workflow breaks down an overall task into a plurality of (less complex) sub-tasks (e.g., microtasks), which when completed completes the overall task. Sub-tasks can include routing sub-tasks, get attendees sub-tasks, get duration sub-tasks, get subject sub-tasks, get location sub-tasks, get phone sub-tasks, get meeting times sub-tasks, get response times sub-tasks, etc. Tasks can include scheduling tasks (meetings, events, etc.), travel requests, expense reports, requisitions, etc.

In general, task agent 101 (e.g., a scheduling agent) is configured to assist with completing tasks for user 107 (and possibly one or more other users). In response to receiving a task, task agent 101 can access a workflow from workflows 112 that corresponds to the task.

Ensemble 102 (of proposition providers) includes proposition providers 102A, 102B, and 102C. The ellipses before, between, and after proposition providers 102A, 102B, 102C represents that other proposition providers can be included in ensemble 102. Each proposition provider in ensemble 102 can use an algorithm to propose one or more solutions for a sub-task. For example, proposition providers 102A, 102B, and 102C can use algorithms 103A, 103B, and 103C respectively. Algorithms at 103A, 103B, 103C (as well as any other algorithms) can be configured with different logic, decision making, artificial intelligence, heuristics, machine learning techniques, natural language processing (NLP) techniques, etc. for proposing sub-task solutions.

For example, algorithms can use NLP techniques, such as, for example, intent detection, entity extraction, and slot filling for processing emails associated with a micro task and gathering relevant information from the emails to automate microtasks, such as, meeting duration and time options. Machine learning can be used to model a microtask, predicting the task output given its input and training data. Machine learning can also be used for modelling confidence estimates of various system inferences, driving workflow decision making Heuristics can be used to automate commonly occurring microtask scenarios, such as, for example, automatically attempting to determine if a received email relates to an existing meeting request or a new meeting request (e.g., by searching properties of the email header)

For each sub-task defined in a workflow, task agent 101 can send the sub-task to ensemble 102. Within ensemble 102, one or more of the proposition providers can be used to automatically generate one or more proposed solutions for the sub-task. In one aspect, each (all) of the proposition providers in ensemble 102 are used to automatically generate one or more proposed solutions for the sub-task. In another aspect, a subset of the proposition providers in ensemble 102 are used to automatically generate one or more proposed solutions for the sub-task. Based at least in part on the corresponding algorithm and/or the sub-task, a proposition provider can automatically generate a single proposed solution for a sub-task or can automatically generate a plurality of proposed solutions for a sub-task.

As depicted, task agent 101 also includes solution predictor 117. Ensemble 102 can return one or more automatically generated proposed solutions for a sub-task to solution provider 117. Solution predictor 117 can receive the one or more automatically generated proposed solutions for the sub-task from ensemble 102. Solution predictor 117 predicts at least one appropriate (e.g., more or most correct) solution for a sub-task form among the one or more automatically generated proposed solutions for the sub-task. When making a prediction, solution predictor 117 can assess a confidence score for each proposed solution. Solution predictor 117 can also consider historical performance of each proposition provider providing one or more automatically generate proposed solutions for a sub-task.

Solution predictor 117 sends the sub-task, the at least one predicted appropriate solution, and the one or more automatically generated proposed solutions to a worker 104. The workers 104 can receive the sub-task, the at least one predicted appropriate solution, and the one or more automatically generated proposed solutions from solution predictor 117.

As depicted, workers 104 includes workers 104A, 104B, etc. Workers 104 can be human workers physically located in one or more different geographic locations. In general, each worker 104 judges one or more automatically generated proposed solutions for a sub-task and determines (verifies), which, if any, of the one or more automatically generated proposed solutions is an appropriate (e.g., more or most correct) solution for the sub-task. In one aspect, a worker 104 indicates (e.g., verifies with a YES/NO verification) a single appropriate solution for a sub-task from among one or more (or a plurality of) proposed solutions. In another aspect, a worker 104 indicates that none of one or more (or a plurality of) proposed solutions is an appropriate solution for a sub-task. In a further aspect, a worker 104 indicates a sub-plurality of appropriate solutions for a sub-task from among a plurality of proposed solutions.

A worker 104 can also alter proposed solutions to a sub-task to increase the appropriateness (correctness) of proposed solutions for the sub-task. Separately and/or in combination with indicating the appropriateness of solutions and/or altering solutions from one or more (or a plurality of) automatically generated proposed solutions for a sub-task, a worker 104 can also indicate that at least one additional solution (not included in the one or more (or plurality of) automatically generated proposed solutions) is an appropriate solution for the sub-task. A worker 104 can create the at least one additional solution de novo and/or can access the at least one additional solution from other computing resources.

A worker 104 can also rank solutions (including automatically generated solutions, altered solutions, and created solutions) relative to one another based on their appropriateness as a solution for a sub-task.

A worker 104 can return a response back to task agent 101 indicating any appropriate solutions, solution rankings, altered solutions, created solutions, etc. Task agent 101 can implement a solution for a sub-task based on the contents of a response from a worker 104.

Task agent 101 can store solution results from sub-task processing in results database 103.

Automating task processing can include machine learning components that learn how to handle sub-tasks through feedback from workers and/or other modules. For example, solution predictor 117 can use responses from workers 104 to improve subsequent predictions. Solution results stored in database 103 can also be used as feedback for training proposition providers in ensemble 102. Thus, over time, proposition providers can be trained to automatically generate more appropriate sub-task solutions and solution predictor 117 can improve at predicting appropriate sub-task solutions. Accordingly, the reliability and effectiveness of automatically solving sub-tasks (e.g., microtasks) can increase over time as sub-tasks (e.g., microtasks) are processed.

Task and sub-task completion can be based on asynchronous communication with one or more entities. For example, when scheduling a meeting, task and sub-task completion can be based on asynchronous communication with requested meeting participants (e.g., asynchronous communication 121 with entities 108). Asynchronous communication can include electronic communication, such as, for example, electronic mail, text messaging, etc. For example, a worker can execute a sub-task that triggers sending an electronic mail message requesting that a person attend a meeting. The worker then waits for a response from the person. The worker can execute additional sub-tasks that trigger sending reminder emails if a response is not received within a specified time period.

A workflow can define relationships between sub-tasks such that some sub-tasks are performed serially and others in parallel. Thus, within a workflow, sub-tasks can be performed in serial and/or in parallel. Some sub-tasks can depend on results from other sub-tasks. These sub-tasks can be performed serially so that results can be propagated. Further sub-tasks may not depend on one another. These further sub-tasks can be performed in parallel.

For example, a sub-task can depend on results from a plurality of other sub-tasks. Thus, the plurality of sub-tasks can be performed in parallel. However, the sub-task is performed after each of the plurality of other sub-tasks completes. In another example, a plurality of sub-tasks depends on results from a sub-task. Thus, the plurality of sub-tasks is performed after the sub-task completes. Different combinations of sub-task pluralities can also depend on another.

The completion of a task can be reflected in user data, such as, for example, in a user's calendar data, requisition date, expense report data, etc.

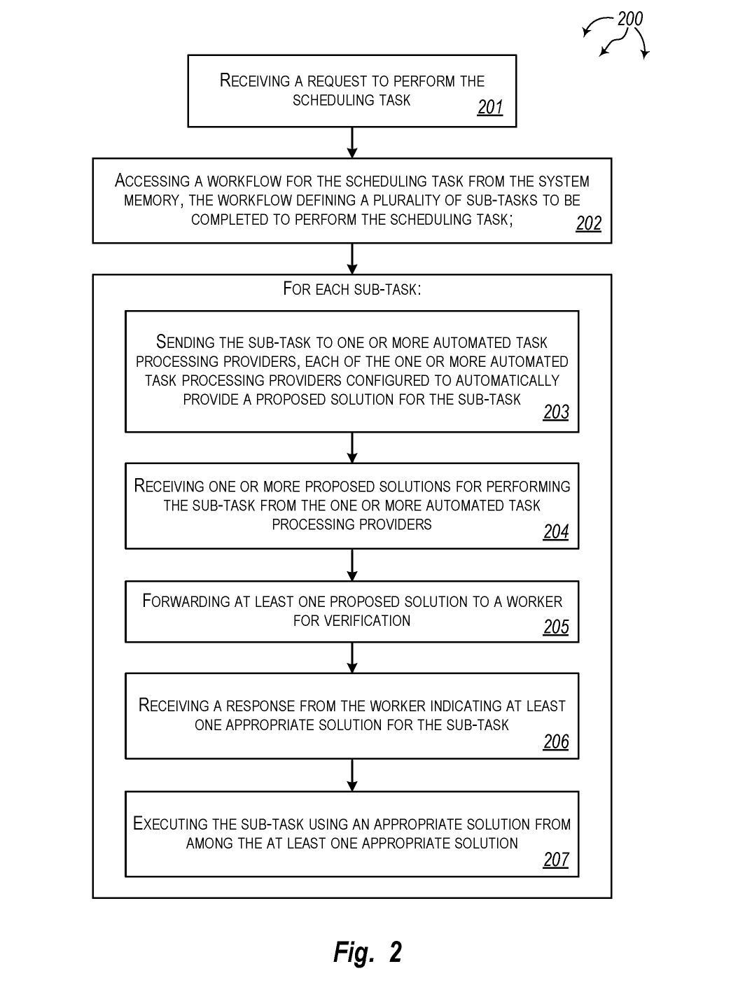

FIG. 2 illustrates a flow chart of an example method 200 for automating task processing. Method 200 will be described with respect to the components and data of computer architecture 100.

Method 200 includes receiving a request to perform the scheduling task (201). For example, user 107 can send a request to perform scheduling task 111 to task agent 101. Task agent 101 can receive scheduling task 111 from user 107. Scheduling task 111 can be a task for scheduling a meeting between user 107 and entities 108. The request can include a time and location and can identify entities 108A, 108B, 108C, etc.

Method 200 includes accessing a workflow for the scheduling task from the system memory, the workflow defining a plurality of sub-tasks to be completed to perform the scheduling task (202). For example, task agent 101 can access workflow 112B (a workflow for scheduling meetings). Workflow 112B defines sub-tasks (e.g., microtasks) 113A, 113, 113C, etc. for completing scheduling task 111.

Method 200 includes, for each sub-task, sending the sub-task to one or more automated task processing providers, each of the one or more automated task processing providers configured to automatically provide a proposed solution for the sub-task (203). For example, task agent 101 can send sub-task 113A (e.g., a microtask) to ensemble 102. Within ensemble 102, each of proposition providers 102A, 102B, and 102C can be configured to provide one or more proposed solutions for sub-task 113A.

Method 200 includes, for each sub-task, receiving one or more proposed solutions for performing the sub-task from the one or more automated task processing providers (204). For example, proposition providers 103A, 103B, and 103C can automatically generate proposed solutions 114 for performing sub-task 113. Proposed solutions 114 includes proposed solutions 114A, 114B, 114C, and 114D. Algorithms at each of proposition providers 103A, 103B, and 103C can automatically generate one or more proposed solutions for performing sub-task 113A. For example, it may be that algorithm 103A automatically generates proposed solution 114A, that algorithm 103B automatically generates proposed solution 114B, and that algorithm 103C automatically generates proposed solutions 114C and 114D.

Task agent 101 can also obtain data (e.g., calendar data) for entities 108A, 108B, and 108C through asynchronous communication 121. Task agent 101 can pass the obtained data to ensemble 102. Proposition providers 102A, 102B, and 102C can use the obtained data when automatically generating proposed solutions for sub-task 113A.

Each of proposition providers 102A, 102B, and 102C may also formulate a confidence score for each proposed solution. For example, proposition provider 102A can formulate confidence score 134A for proposed solution 114A, proposition provider 102B can formulate confidence score 134B for proposed solution 114B, and proposition provider 102C can formulate confidence scores 134C and 134D for each of proposed solutions 114C and 114D.

A confidence score indicates how confident a proposition provider is in the appropriateness of a proposed solution for a sub-task. For example, confidence score 134A indicates how confident proposition provider 102A is that proposed solution 114A is an appropriate solution for sub-task 113. Confidence score 134B indicates how confident proposition provider 102B is that proposed solution 114B is an appropriate solution for sub-task 113. Confidence scores 134C and 134D respectively indicate how confident proposition provider 102C is that proposed solutions 114C and 114D are appropriate solutions for sub-task 113. Confidence scores 134C and 134D may be the same or different. For example, algorithm 103C can generate proposed solutions 114C and 114D. However, proposition provider 102C may be more confident that proposed solution 114C is an appropriate solution for sub-task 113 relative to proposed solution 114D or vice versa.

A confidence score can be used to indicate a purported appropriateness or inappropriateness of a proposed solution. For example, a proposition provider may have increased confidence that a proposed solution is appropriate or inappropriate as indicated by a higher confidence score. On the other hand, a proposition provider may have decreased confidence that a proposed solution is appropriate or inappropriate as indicated by a lower confidence score. Whether or not confidence scores from a proposition provider accurately reflect appropriateness of proposed solutions (i.e., historical performance) can be evaluated over time (e.g., by solution predictor 117) based at least in part on responses from workers 104. For example, it may be that a proposition provider tends to use higher confidence scores for its proposed solutions. However, human workers frequently change the proposed solutions, indicate the proposed solutions are not appropriate, etc. Thus, historical performance of the proposition provider is less favorable.

Ensemble 102 can return proposed solutions 114 (along with confidence scores) to task agent 101. Task agent 101 can receive proposed solutions 114 (along with confidence scores) from ensemble 102. In one aspect, at least one proposition provider in ensemble 102 formulates a confidence score and at least one proposition provider in ensemble 102 does not formulate a confidence score.

Method 200 includes forwarding at least one proposed solution to a worker for validation (205). For example, solution predictor 117 can access each of proposed solutions 114A, 114B, 114C, and 114D. Solution predictor 117 can predict that one or more of proposed solutions 114A, 114B, 114C, and 114D is appropriate for performing sub-task 113. Solution predictor 117 can consider sub-task 113A, proposed solutions 114A, 114B, 114C, and 114D, confidence scores 134A, 134B, 134C, and 134D, along with historical performance for each of proposition providers 102A, 102B, and 102C.

As described, historical performance can indicate how accurately confidence scores correlate to actual appropriateness (correctness) or inappropriateness (incorrectness) for a proposition provider. For example, it may be that a proposition provider frequently, but inaccurately, indicates its proposed solutions are appropriate with a relatively high confidence score. As such, a human worker 104 may often indicate that the proposed solutions are actually not appropriate solutions. Thus, the historical performance of the proposition provider can be viewed as lower (or less favorably). On the other hand, it may be that another proposition provider more accurately indicates its proposed solutions as appropriate or inappropriate with a relatively high confidence score. A human worker 104 may often confirm indications from the proposition provider. Thus, the historical performance of the other proposition provider can be viewed as higher (or more favorably).

In one aspect, solution predictor 117 filters out proposed solutions for various reasons. Solution predictor 117 can filter out any proposed solutions that are indicated to be inappropriate and have a confidence score above a first specified confidence threshold. Solution predictor 117 can filter out any proposed solutions having a confidence score below a second specified confidence threshold. Solution predictor can filter out any proposed solutions from proposition providers having historical performance below a historical performance threshold.

Based on sub-task 113A, proposed solutions 114A, 114B, 114C, and 114D, confidence scores 134A, 134B, 134C, and 134D, along with historical performance for each of proposition providers 102A, 102B, and 102C, solution predictor 117 can derive that predicted solution 118 (one of proposed solutions 114A, 114B, 114C, and 114D) is an appropriate solution for sub-task 118. Solution predictor 117 can send sub-task 113A, predicted solution 118, and proposed solutions 114 to worker 104A.

In one aspect, sub-task 113A, predicted solution 118, and proposed solutions 114 are presented to worker 104A through a (e.g., graphical) user-interface. Through the user-interface, worker 104A can review predicted solution 118 relative to proposed solutions 114. In one aspect, worker 104A determines that predicted solution 118 is an appropriate (e.g., a correct) solution for sub-task 113A. As such, worker 104A can verify (e.g., indicating YES through a YES/NO verification) that predicted solution 118 is appropriate through the user-interface. It takes less time and consumes fewer resources for worker 104A to verify predicted solution 118 than for worker 104A to create a solution for sub-task 113A from scratch.

In another aspect, worker 104A determines that predicted solution 118 is inappropriate for sub-task 113A (e.g., indicating NO through a YES/NO verification) due to one or more deficiencies. Worker 104A can take various actions to correct the one or more deficiencies. For example, worker 104A can make a change to (e.g., edit) at least one aspect of predicted solution 118 to alter predicted solution 118 into an appropriate solution for sub-task 113A. Alternatively, worker 104A can determine that a further solution not already included in proposed solutions 114 is an appropriate solution for sub-task 113A. Worker 104A can access the further solution from other computing resources (e.g., a database, a file, etc.). It takes less time and consumes fewer takes for worker 104A to change a predicted solution or access a further solution from other computing resource than to create a solution for sub-task 113A from scratch.

In an additional alternative, worker 104A can create the further solution de novo (e.g., through the user-interface).

In a further aspect, worker 104A ranks the appropriateness of a plurality of different solutions for sub-task 113A relative to one another. A ranking for a solution can indicate an effectiveness of the solution for sub-task 113A relative to other solutions. For example, worker 104A may rank a top three more appropriate solutions for sub-task 113A.

Worker 104A can generate response 119. Response 119 can indicate any of: that predicated solution 118 was verified by worker 104A as an appropriate solution for sub-task 113A, that one or more (or even all) of proposed solutions 114A, 114B, 114C, and 114D were inappropriate solutions for sub-task 113A, or that an appropriate solution for sub-task 113A was not included in proposed solutions 114.

Response 119 can indicate at least one appropriate solution for sub-task 113A. The at least one appropriate solution can include predicted solution 118, any of proposed solutions 114A, 114B, 114C, or 114D, a solution formed by altering any of proposed solutions 114A, 114B, 114C, or 114D in some way, a further solution accessed from other computer resources, or a further solution created de novo by worker 104A. In one aspect, response 119 includes a plurality of appropriate (and potentially ranked) solutions for sub-task 113A.

Method 200 includes receiving a response from the worker indicating at least one appropriate solution for the sub-task (206). For example, solution predictor 117 can receive response 119 from worker 104A. Method 200 includes executing the sub-task using an appropriate solution from among the at least one appropriate solution (207). For example, task agent 101 can execute sub-task 113A using an appropriate solution for sub-task 103 included in response 119.

Task agent 101 can also provide the response to a database for use as feedback to train training the one or more automated task processing providers. For example, task agent 101 can store response 119 in database 103. Response 119 can be merged into solution results 116 that indicates prior results of proposing and predicting solutions for sub-tasks. Solution predictor 117 can use solution results 116 to make improved solution predictions for other sub-tasks. Solution results 116 can also be used to formulate feedback 132 for training proposition providers in ensemble 102. Accordingly, the effectiveness of automating task processing can improve over time as additional sub-tasks are executed and more data is gathered.

After sub-task 113A is executed, other sub-tasks in task 111, such as, for example, sub-task 113B, sub-task 113C, etc. can be executed in a similar manner until task 111 is completed. When task 111 is completed, calendar update 129 can be entered in user 107's calendar.

Completing task 111 can include asynchronous communication 121 with entities 108. Task agent 101 can use asynchronous communication 121 to obtain information from entities 108 for use in executing sub-tasks.

Automated Task Processing With Escalation

Examples extend to methods, systems, and computer program products for automated task processing with escalation. A request to perform a task (e.g., scheduling a meeting between multiple participants) is received. A workflow for the task is accessed. The workflow defines a plurality of sub-tasks to be completed to perform the task.

For each sub-task, it is determined if performance of the sub-task can be automated based on: the task, any information obtained through asynchronous communication with the one or more entities associated with the task, and results of previously performed sub-tasks. When the sub-task can be automated, the sub-task is sent to an automated task processing module and results of performing the sub-task from the task processing module is received. When the sub-task cannot be automated, the sub-task is escalated to a worker to be performed. When the sub-task cannot be performed by the worker, the task is escalated to a more skilled worker to be performed.

Aspects of the invention process tasks taking advantage of machine learning and micro tasks with mechanisms to escalate micro tasks to micro workers and escalate tasks to macro workers to appropriately solve problems. An overall task to be achieved (e.g., scheduling a meeting between multiple participants) can be broken down into a grouping of (e.g., loosely-coupled) asynchronous sub-tasks (e.g., micro tasks). Completing the grouping of sub-tasks completes the overall task. Execution of tasks is handled by a workflow engine. The workflow engine can process sub-tasks serially and/or in parallel based on inputs to and results from other sub-tasks.

Performance of sub-tasks (e.g., micro tasks) for an overall task can be automated as appropriate based on machine learning from prior performance of the task and/or prior performance related tasks. Sub-tasks (e.g., micro tasks) that are not automatable can be escalated to micro workers (e.g., less skilled workers, crowd-sourced unskilled workers, etc.). When a micro worker performs a sub-task (e.g., a micro task), results from performance of the sub-task can be used as feedback to train the machine learning.

When a micro worker is unable to perform a sub-task (e.g., a micro task), the overall task can be escalated to a macro worker (e.g., a trained worker, a worker with improved language skills, a worker with cultural knowledge) etc. The macro worker can perform the overall task. For example, when scheduling a meeting, a macro work can identify meeting participants, a desired meeting time, duration, location, and subject. The macro worker can mail to any meeting participant or send a meeting invitation. When a sub-task (e.g., micro task) is waiting for human input, the macro task worker can make the sub-task as pending and go on to other sub-tasks.

The sub-task can be monitored and the macro task can be reactivated when there is more work to be done. Sub-tasks can be restarted when they have waited too long. A macro worker can send a reminder that a response is requested.

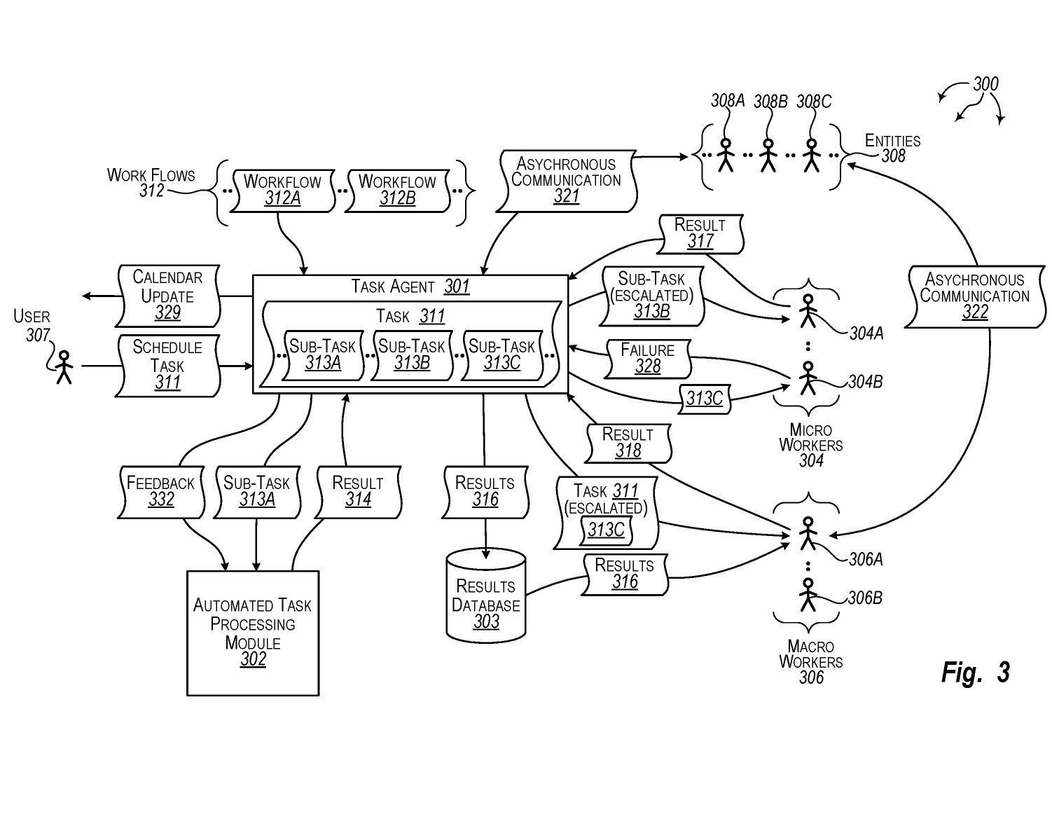

FIG. 3 illustrates an example computer architecture 300 that facilitates automated task processing with escalation. Referring to FIG. 3, computer architecture 300 includes task agent 301, automated task processing module 302, results database 303, micro workers 305, macro workers 306, user 307 and entities 308. Task agent 301, automated task processing module 302, results database 303, micro workers 305, macro workers 306, user 307 and entities 308 can be connected to (or be part of) a network, such as, for example, a Local Area Network (“LAN”), a Wide Area Network (“WAN”), and even the Internet. Accordingly, task agent 301, automated task processing module 302, results database 303, micro workers 305, macro workers 306, user 307 and entities 308, as well as any other connected computer systems and their components, can create message related data and exchange message related data (e.g., Internet Protocol (“IP”) datagrams and other higher layer protocols that utilize IP datagrams, such as, Transmission Control Protocol (“TCP”), Hypertext Transfer Protocol (“HTTP”), Simple Mail Transfer Protocol (“SMTP”), Simple Object Access Protocol (SOAP), etc. or using other non-datagram protocols) over the network.

As depicted, micro workers 304 includes micro workers 304A, 304B, etc. Micro workers 304 can be human workers physically located in one or more different geographic locations. In general, micro workers 304 are able to handle less complex tasks (e.g., sub-tasks). Micro workers 304 can be less skilled workers, crowd-sourced unskilled workers, etc.

Macro workers 306 includes macro workers 306A, 306B, etc. Macro workers 306 can be human workers physically located in one or more different geographic locations and located at the same or different geographic locations than any of micro workers 304. In general, macro workers 304 are able to handle more complex tasks (e.g., overall scheduling tasks). Macro workers 306 can be trained workers, workers with improved language skills, workers with cultural knowledge, etc.

Workflows 312 includes workflows 312A, 312B, etc. Each of workflows 312 defines a plurality of sub-tasks to be completed to perform a task. That is, a workflow breaks down an overall task into a plurality of (less complex) sub-tasks, which when completed completes the overall task. Sub-tasks can include routing sub-tasks, get attendees sub-tasks, get duration sub-tasks, get subject sub-tasks, get location sub-tasks, get phone sub-tasks, get meeting times sub-tasks, get response times sub-tasks, etc. Tasks can include scheduling tasks (meetings, events, etc.), travel requests, expense reports, requisitions, etc.

In general, task agent 301 (e.g., a scheduling agent) is configured to assist with completing tasks for user 307 (and possibly one or more other users). In response to receiving a task, task agent 301 can access a workflow from workflows 312 that corresponds to the task.

For each sub-task define in a workflow, task agent 301 can determine if automated task processing module 302 has the capability to automate performance of the sub-task. When automated task processing module 302 has the capability to automate a sub-task, task agent 301 can send the sub-task to automated task processing module 302. Automated task processing module 302 can perform the sub-task (without human intervention). Automated task processing module 302 can return results of performing the sub-task back to task agent 301.

On the other hand, when automated task processing module 302 lacks the capability to automate a sub-task, task agent 301 can automatically escalate the sub-task to a micro worker 304. The micro worker can perform the sub-task and results of performing the sub-task can be returned back to task agent 301.

Automated task processing module 302 can include machine learning components that learn how to handle sub-tasks through feedback from other modules. For example, task agent 301 can use results from micro worker performance of sub-tasks as feedback to train automated task processing module 301. Accordingly, automated processing of sub-tasks can increase over time as automated task processing module 301 is trained to handle additional sub-tasks.

Results from sub-task processing (both automated and micro worker) can be stored in results database 303. During sub-task performance (either automated or micro worker), a sub-task may refer to results from previously performed sub-tasks stored in results database 303. The sub-task can use stored results to make progress in completing.

When a micro worker lacks the capability to perform a sub-task (or cannot perform a sub-task for some other reason), task agent 301 can automatically escalate a task (i.e., an overall task) to a macro worker. To escalate a task to a macro worker, results from performed sub-tasks along with any remaining unperformed sub-tasks can be sent to the macro worker. The macro worker can use results from performed sub-tasks to complete remaining unperformed sub-tasks. Completion of remaining unperformed sub-tasks in turn completes the (overall) task.

Task and sub-task completion can be based on asynchronous communication with one or more entities. For example, when scheduling a meeting, task and sub-task completion can be based on asynchronous communicate with requested meeting participants. Asynchronous communication can include electronic communication, such as, for example, electronic mail, text messaging, etc. For example, a worker can send an electronic mail message requesting that a person attend a meeting. The worker then waits for a response from the person. The worker can send reminder emails if a response is not received within a specified time period.

Aspects of the invention permit the worker to move on to other tasks while waiting for a response from a person. When a response arrives, one of the workers can be informed and can resume processing the request. Messages are monitored freeing up workers to be more productive. Also, tasks can be handled by any on-shift worker and do not depend on the availability of a specific worker

A workflow can define relationships between sub-tasks such that some sub-tasks are performed serially and others in parallel. Thus, within a workflow, sub-tasks can be performed in serial and/or in parallel. Some sub-tasks can depend on results from other sub-tasks. These sub-tasks can be performed serially so that results can be propagated. Further sub-tasks may not depend on one another. These further sub-tasks can be performed in parallel.

For example, a sub-task can depend on results from a plurality of other sub-tasks. Thus, the plurality of sub-tasks can be performed in parallel. However, the sub-task is performed after each of the plurality of other sub-tasks completes. In another example, a plurality of sub-tasks depends on results from a sub-task. Thus, the plurality of sub-tasks is performed after the sub-task completes. Different combinations of sub-task pluralities can also depend on another.

The completion of a task can be reflected in user data, such as, for example, in a user's calendar data, requisition date, expense report data, etc.

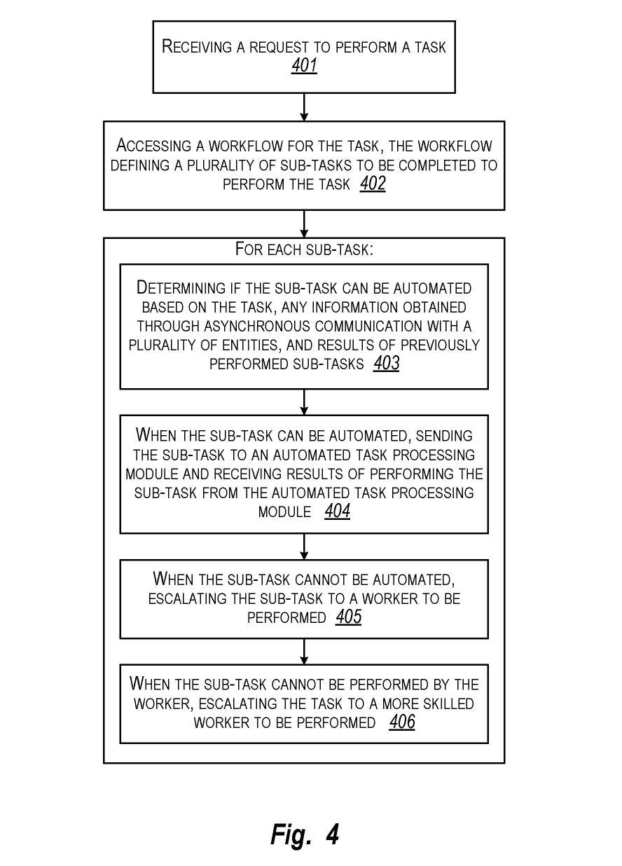

FIG. 4 illustrates a flow chart of an example method for automated task processing with escalation. Method 400 will be described with respect to the components and data of computer architecture 300.

Method 400 includes receiving a request to perform the task (401). For example, task agent 301 can receive scheduling task 311 from user 307. Scheduling task 311 can be a task for scheduling a meeting between user 307 and entities 308. The request can include a time and location and can identify entities 308A, 308B, 308C, etc.

Method 400 includes accessing a workflow for the task, the workflow defining a plurality of sub-tasks to be completed to perform the task (402). For example, task agent 301 can access workflow 312A (a workflow for scheduling meetings). Workflow 312A defines sub-tasks 313A, 313B, 313C, etc. for scheduling task 311.

For each sub-task, method 400 includes determining if performance of the sub-task can be automated based on the task, any information obtained through asynchronous communication with the one or more entities, and results of previously performed sub-tasks (403). For example, task agent 301 can determine if automated task processing module 302 has capabilities to automate each of sub-tasks 313A, 313B, 313C, etc. For each sub-task, the determination can be based on scheduling task 311, asynchronous communication with one or more of entities 308A, 308B, 308C, etc., and results (e.g., stored in results database 303) of previously performed sub-tasks.

For each sub-task, when the sub-task can be automated, method 400 includes sending the sub-task to an automated task processing module and receiving results of performing the sub-task from the task processing module (404). For example, task agent 301 can determine that automated task processing module 302 has capabilities to automate sub-task 313A based on task 311, communication from one or more of entities 308A, 308B, 308C, etc., and results stored in results database 303. As such, task agent 301 can send sub-task 313A to automated task processing module 302.

Automated task processing module 302 can perform sub-task 313A and return results 314 to task agent 301. Results 314 can be stored in results database 303

Other automatable sub-tasks can be performed in a similar manner.

For each sub-task, when the sub-task cannot be automated, escalating the sub-task to a worker to be performed (405). For example, task agent 301 can determine that automated task processing module 302 lacks capabilities to automate sub-task 313B based on task 311, communication from one or more of entities 308A, 308B, 308C, etc., and results stored in results database 303. As such, task agent 301 can escalate sub-task 313B to micro worker 304A. Micro worker 304A performs sub-task 313B and returns results 317 to task agent 301. Results 317 can be stored in results database 303.

Task agent 301 can also use result 317 to formulate feedback 332. Task agent 301 can send feedback 332 to automated task processing module 302 as training data. Automated task processing module 302 can used feedback 332 to train machine learning components. For example, feedback 332 can train machine learning components so that processing future instances of sub-task 313B (and/or or similar sub-tasks) can be automated.

Task agent 301 can also determine that automated task processing module 302 lacks capabilities to automate sub-task 313C based on task 311, communication from one or more of entities 308A, 308B, 308C, etc., and results stored in results database 303. As such, task agent 301 can escalate sub-task 313C to micro worker 304B. However, micro worker 304B may be unable to complete sub-task 313B (e.g., due to lack of training, language skills, or other reasons). Micro worker 304B can return failure 328 to task agent 301 indicating an inability to process sub-task 313C.

For each sub-task, when the sub-task cannot be performed by the worker, escalating the task to a more skilled worker to be performed (406). For example, when sub-task 313B cannot be performed by micro worker 304B, task agent 301 can escalate task 311 to macro worker 306A. Any remaining unperformed sub-tasks and results from previously performed sub-tasks can be sent to macro worker 306A. For example, results 316 (i.e., the collective results from automated and micro worker performed sub-tasks, including results 314 and 317) and sub-task 313C (as well as other unperformed sub-tasks defined in workflow 312A) can be sent to macro worker 306A. Macro worker 306B can complete performance of task 311. Results 318 from completing task 311 can be sent back to task agent 301. Task agent 301 can use results 318 to update data for user 307, such as, for example, with calendar update 329.

Completing task 311 can include asynchronous communication 321 and/or asynchronous communication 322. Task agent 301 can use asynchronous communication 321 to obtain information from entities 308 for sub-task completion by automated task processing module 302 and/or micro workers 304. In other aspects, automated task processing module 302 and/or micro workers 304 can conduct asynchronous communication with entities 308 (alternately or in addition to asynchronous communication 321).

Macro worker 306A can use asynchronous communication 322 to obtain information from entities 308 to complete task 311.

Combined Aspects

Various aspects of the invention can also be combined. For example, tasks can be executed using automated proposition providers and a solution predictor for micro-task execution along with micro-task and/or macro task escalation. For example, components from both computer architectures 100 and 300 can be used together to perform methods including aspects of both methods 200 and 400 to perform tasks in an automated fashion.

In some aspects, a computer system comprises one or more hardware processors and system memory. The system memory is coupled to the one or more hardware processors. The system memory stores instructions that are executable by the one or more hardware processors. The one or more hardware processors execute the instructions stored in the system memory to handle a scheduling task.

The one or more hardware processors execute the instructions to receive a request to perform the scheduling task. The one or more hardware processors execute the instructions to access a workflow for the scheduling task from the system memory. The workflow defines a plurality of sub-tasks to be completed to perform the scheduling task.

The one or more hardware processors execute the instructions to, for each sub-task in the plurality of sub-tasks, send the sub-task to one or more automated task processing providers. Each of the one or more automated task processing providers for automatically providing a proposed solution for the sub-task. The one or more hardware processors execute the instructions to receive one or more proposed solutions for performing the sub-task from the one or more automated task processing providers.

The one or more hardware processors execute the instructions to, for each sub-task in the plurality of sub-tasks, forward at least one proposed solution for performing the sub-task to a worker for verification. The one or more hardware processors execute the instructions to, for each sub-task in the plurality of sub-tasks, receive a response from the worker indicating at least one appropriate solution for the sub-task. The one or more hardware processors execute the instructions to, for each sub-task in the plurality of sub-tasks, execute the sub-task using an appropriate solution from among the at least one appropriate solution.

Computer implemented methods for performing the executed instructions to handle a scheduling task are also contemplated. Computer program products storing the instructions, that when executed by a processor, cause a computer system to handle a scheduling task are also contemplated.

The present described aspects may be implemented in other specific forms without departing from its spirit or essential characteristics. The described aspects are to be considered in all respects only as illustrative and not restrictive. The scope is, therefore, indicated by the appended claims rather than by the foregoing description. All changes which come within the meaning and range of equivalency of the claims are to be embraced within their scope.

What is claimed:

1. A computer system, the computer system comprising:
one or more hardware processors;
system memory coupled to the one or more hardware processors, the system memory storing instructions that are executable by the one or more hardware processors;
the one or more hardware processors executing the instructions stored in the system memory to handle a scheduling task, including the following:
receive a request to perform the scheduling task;
access a workflow for the scheduling task from the system memory, the workflow defining a plurality of sub-tasks to be completed to perform the scheduling task;
for each sub-task in the plurality of sub-tasks:
send the sub-task to one or more automated task processing providers, each of the one or more automated task processing providers for automatically providing a proposed solution for the sub-task; and
receive one or more proposed solutions for performing the sub-task from the one or more automated task processing providers;
forward at least one proposed solution for performing the sub-task to a worker for verification;
receive a response from the worker indicating at least one appropriate solution for the sub-task; and
execute the sub-task using an appropriate solution from among the at least one appropriate solution.

2. The computer system of claim 1, wherein the one or more hardware processors executing the instructions stored in the system memory to receive a response from the worker comprise the one or more hardware processors executing the instructions stored in the system memory to receive a response indicating that one or more of the proposed solutions for the sub-task were inappropriate; and
further comprising the one or more hardware processors executing the instructions stored in the system memory to provide the response as feedback for training the one or more automated task processing providers.

3. The computer system of claim 1, wherein the one or more hardware processors executing the instructions stored in the system memory to send the sub-task to one or more automated task processing providers comprise the one or more hardware processors executing the instructions stored in the system memory to send the sub-task to a plurality of automated task processing providers.

4. The computer system of claim 3, wherein the one or more hardware processors executing the instructions stored in the system memory to send the sub-task to a plurality of automated task processing providers comprise the one or more hardware processors executing the instructions stored in the system memory to:
send the sub-task to a first automated task processing provider that uses a first algorithm to formulate sub-task solutions; and
send the sub-task to a second automated task processing provider that uses a second algorithm to formulate sub-task solutions, the second algorithm differing from the first algorithm.

5. The computer system of claim 3, wherein the one or more hardware processors executing the instructions stored in the system memory to receive one or more proposed solutions for performing the sub-task from the one or more automated task processing providers comprises the one or more hardware processors executing the instructions stored in the system memory to receive a plurality of proposed solutions for performing the sub-task, the plurality of proposed solutions including at least one proposed solution from each of the plurality of automated task processing providers.

6. The computer system of claim 5, wherein the one or more hardware processors executing the instructions stored in the system memory to receive a response from the worker indicating at least one appropriate solution for the sub-task comprise the one or more hardware processors executing the instructions stored in the system memory to receive a response from the worker ranking each of the plurality of proposed solutions relative to one another, a ranking for a proposed solution indicating an effectiveness of the solution for the sub-task relative to other solutions included in the plurality of solutions

7. The computer system of claim 1, wherein the one or more hardware processors executing the instructions stored in the system memory to receive one or more proposed solutions for performing the sub-task from the one or more automated task processing providers comprise the one or more hardware processors executing the instructions stored in the system memory to receive a plurality of solutions for performing the sub-task from the one or more automated task processing providers.

8. The computer system of claim 1, wherein the one or more hardware processors executing the instructions stored in the system memory to receive a response from the worker indicating at least one appropriate solution for the sub-task comprise the one or more hardware processors executing the instructions stored in the system memory to receive a response from the worker validating a proposed solution, from among the one or more proposed solutions, as an appropriate solution for the sub-task.

9. The computer system of claim 1, wherein the one or more hardware processors executing the instructions stored in the system memory to receive a response from the worker indicating at least one appropriate solution for the sub-task comprise the one or more hardware processors executing the instructions stored in the system memory to receive a response from the worker indicating a solution for the sub-task that was not included in the one or more proposed solutions.

10. The computer system of claim 1, wherein the one or more hardware processors executing the instructions stored in the system memory to receive a response from the worker indicating a solution for the sub-task that was not included in the one or more proposed solutions comprise the one or more hardware processors executing the instructions stored in the system memory to receive a solution for the sub-task that was formulated de novo by the worker.

11. The method of claim 1, wherein the one or more hardware processors executing the instructions stored in the system memory to receive a response from the worker indicating a solution for the sub-task that was not included in the one or more proposed solutions comprise the one or more hardware processors executing the instructions stored in the system memory to receive an altered solution for the sub-task, the altered solution formulated from a proposed solution included in the one or more proposed solutions, the altered solution also having at least one change from the proposed solution.

12. The method of claim 1, further comprising the one or more hardware processors executing the instructions stored in the system memory to provide the response as feedback for training the one or more automated task processing providers.

13. A method for use at a computer system, the method for handling a scheduling task, the method comprising:
receiving a request to perform the scheduling task;
accessing a workflow for the scheduling task from the system memory, the workflow defining a plurality of sub-tasks to be completed to perform the scheduling task;
for each sub-task in the plurality of sub-tasks:
sending the sub-task to one or more automated task processing providers, each of the one or more automated task processing providers configured to automatically provide a proposed solution for the sub-task;
receiving one or more proposed solutions for performing the sub-task from the one or more automated task processing providers;
forwarding the one or more proposed solutions to a worker for verification;
receiving a response from the worker indicating at least one appropriate solution for the sub-task;
executing the sub-task using an appropriate solution from among the at least one appropriate solution.

14. The method of claim 13, wherein receiving a response from the worker comprises receiving a response indicating that one or more of the proposed solutions for the sub-task were inappropriate; and
further comprising providing the response as feedback for training the one or more automated task processing providers.

15. The method of claim 13, wherein sending the sub-task to one or more automated task processing providers comprises sending the sub-task to a plurality of automated task processing providers, including:
sending the sub-task to a first automated task processing provider that uses a first algorithm to formulate sub-task solutions; and
sending the sub-task to a second automated task processing provider that uses a second algorithm to formulate sub-task solutions, the second algorithm differing from the first algorithm.

16. The method of claim 15, wherein receiving one or more proposed solutions for performing the sub-task from the one or more automated task processing providers comprises receiving a plurality of proposed solutions for performing the sub-task, the plurality of proposed solutions including at least one proposed solution from each of the plurality of automated task processing providers; and
wherein receiving a response from the worker indicating at least one appropriate solution for the sub-task comprises receiving a response from the worker ranking each of the plurality of proposed solutions relative to one another, a ranking for a proposed solution indicating an effectiveness of the solution for the sub-task relative to other solutions included in the plurality of solutions

17. The method of claim 13, wherein receiving a response from the worker indicating at least one appropriate solution for the sub-task comprises receiving a response from the worker validating a proposed solution, from among the one or more proposed solutions, as an appropriate solution for the sub-task.

18. The method of claim 13, wherein receiving a response from the worker indicating a solution for the sub-task that was not included in the one or more proposed solutions comprises receiving a solution for the sub-task that was formulated de novo by the worker.

19. The method of claim 13, wherein receiving a response from the worker indicating a solution for the sub-task that was not included in the one or more proposed solutions comprises receiving an altered solution for the sub-task, the altered solution formulated from a proposed solution included in the one or more proposed solutions, the altered solution also having at least one change from the proposed solution.

20. A computer program product for use at a computer system, the computer program product for implementing a method for handling a scheduling task, the computer program product comprises one or more computer storage devices having stored thereon computer-executable instructions that, when executed at a processor, cause the computer system to perform the method, including the following:
receive a request to perform the scheduling task;
access a workflow for the scheduling task from the system memory, the workflow defining a plurality of sub-tasks to be completed to perform the scheduling task;
for each sub-task in the plurality of sub-tasks:
send the sub-task to one or more automated task processing providers, each of the one or more automated task processing providers for automatically providing a proposed solution for the sub-task;
receive one or more proposed solutions for performing the sub-task from the one or more automated task processing providers;
forward at least one proposed solution for performing the sub-task to a worker for verification;
receive a response from the worker indicating at least one appropriate solution for the sub-task; and
execute the sub-task using an appropriate solution from among the at least one appropriate solution.
